(19) United States
(12) Patent Application Publication
(10) Pub. No.: US 2002/0104095 A1
(43) Pub. Date: Aug. 1, 2002

(54) On-remote-control email and other service indicator methods, systems, and devices

(76) Inventors: Loc Nguyen, Issaquah, WA (US); Paul G. Allen, Mercer Island, WA (US)

Correspondence Address: DIGEO, INC C/O STOEL RIVES LLP, 201 SOUTH MAIN STREET, SUITE 1100, ONE UTAH CENTER, SALT LAKE CITY, UT, 84111, US

(21) Appl. No.: 09/894,431

(22) Filed: Jun. 27, 2001

Related U.S. Application Data
(63) Continuation-in-part of application No. 09/703,272, filed on Oct. 31, 2000.
(63) Continuation-in-part of application No. 09/703,261, filed on Oct. 31, 2000.
(60) Provisional application No. 60/284,767, filed on Apr. 18, 2001.
(60) Provisional application No. 60/238,581, filed on Oct. 6, 2000.
(60) Provisional application No. 60/238,581, filed on Oct. 6, 2000.

(51) Int. Cl. G06F 3/00; H04N 5/445; G06F 13/00; H04N 7/173; H04N 7/16

(52) U.S. Cl. 725/110; 725/141; 725/108

(57) ABSTRACT

An apparatus for providing notification to user in an interactive television system includes: a customer premise equipment capable to receive information from a data communication network and transmit an alert signal in response to receiving the information; and a notification device capable to receive the alert signal and to provide notification to a user in response to the alert signal.

### CROSS-REFERENCE TO RELATED APPLICATIONS

The present application claims priority to U.S. Provisional Application No. 60/284,767, by common inventors, Loc Nguyen and Paul G. Allen, filed Apr. 18, 2001, and entitled “ON-REMOTE-CONTROL EMAIL AND OTHER SERVICE INDICATOR LED AND SOUND”. Application No. 60/284,767 is fully incorporated herein by reference.

The present application is a continuation-in-part of and claims the benefit of U.S. patent application Ser. No. 09/703,272, entitled “USER INTERFACE FOR PERSONALIZED ACCESS TO INTERNET-ENABLED TELEVISION,” by Paul G. Allen, Anthony F. Istvan, and Armando P. Stettner, filed Oct. 31, 2000, which claims the benefit of U.S. Provisional Patent Application Serial No. 60/238,581, entitled “USER INTERFACE, SYSTEM, AND METHOD FOR PERSONALIZED ACCESS TO INTERNET-ENABLED TV,” by Paul G. Allen, Anthony F. Istvan, and Armando P. Stettner, filed Oct. 6, 2000.

The present application is a continuation-in-part of and claims the benefit of U.S. patent application Ser. No. 09/703,261, entitled “SYSTEMS AND METHODS FOR PERSONALIZED ACCESS TO INTERNET-ENABLED TELEVISION,” by Paul G. Allen, Anthony F. Istvan, Armando P. Stettner, filed Oct. 31, 2000, which claims the benefit of U.S. Provisional Patent Application Serial No. 60/238,581, entitled “USER INTERFACE, SYSTEM, AND METHOD FOR PERSONALIZED ACCESS TO INTERNET-ENABLED TV,” by Paul G. Allen, Anthony F. Istvan, and Armando P. Stettner, filed Oct. 6, 2000.

Application Ser. Nos. 09/703,272, 09/703,261, and 60/238,581 are each fully incorporated herein by reference.

### TECHNICAL FIELD

This disclosure relates generally to interactive television (iTV) systems, and more particularly but not exclusively, to systems, devices, and methods for providing notification of electronic mail (email) messages, instant messages, and/or other services/information to a user of an interactive television system.

### BACKGROUND

An interactive television (iTV) differs from a conventional television in that an interactive television includes additional information and communication technology capabilities. These additional capabilities open up the possibilities for offering services or functions that are traditionally unavailable by use of conventional televisions. An iTV may, for example, have the capability to permit electronic mail (email) or video mail communication, web browsing, and/or other functions or services.

Presently, a conventional iTV user is required to be in the vicinity of the television in order to be notified of a new email messages or the availability of other services. For example, the iTV user is required to turn on the television, activate the email menu, and view the television screen in order to determine if a new email message has arrived. In addition, if the iTV user goes to other rooms within the house or building, then the user will not be informed of new email messages, instant messages, or other services/information until the user returns to the vicinity of the iTV system and checks the television screen. Thus, conventional iTV systems may present some inconvenience to users when email or other services are used.

Accordingly, there is need for a new system, device, and method to permit easier use of services provided by iTV systems.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of an interactive television system that can implement an embodiment of the invention.

FIG. 2 is a block diagram of a notification device (e.g., a remote control device) according to an embodiment of the invention.

FIG. 3 is a block diagram of various components in a notification device according to an embodiment of the invention.

FIG. 4 is a flowchart of a method to permit remote notification to an interactive television user according to an embodiment of the invention.

FIG. 5 is a block diagram of an interactive television system according to another embodiment of the invention.

### DETAILED DESCRIPTION OF THE ILLUSTRATED EMBODIMENTS

Embodiments of a remote notification system and method for an interactive television user are disclosed herein. As an overview, an embodiment of the invention provides an apparatus and method that permit the interactive television user to be notified of email messages, instant messages, or/and other newly-received information without requiring the user to be in the vicinity of the interactive television system. The apparatus may include: a customer premise equipment, such as a set top box, that is capable to receive information from a data communication network and transmit an alert signal in response to receiving the information; and a notification device (e.g., a remote control device) capable to receive the alert signal and to provide notification to a user in response to the alert signal. The information received from the data communication network may be, for example, an electronic mail message, an instant message, and/or other types of data or information. The notification device can notify the iTV customer of the newly-received information by enabling visual effects (e.g., LED lights), sound/audio effects, and/or physical vibration of the notification device.

The invention advantageously permits the iTV customer to be instantly notified of new email messages, instant messages and/or other information, while roaming other parts of a house or building, and/or while performing other tasks such as dinner preparation or working in a garage. Thus, the iTV customer no longer has to be constrained in the vicinity of the television when waiting for an email message or other information that is to be received by the iTV system. The iTV customer is notified of the new email message, instant message, and/or other information without having to turn on the television and/or without having to check the television screen and relevant menu. Thus, an embodiment of the invention would advantageously add a layer of service to currently provided services in iTV systems and would simulate a type of “service butler” that remotely notifies the user of newly-received information in the iTV system.

In the description herein, numerous specific details are provided, such as examples of system components and methods, to provide a thorough understanding of embodiments of the invention. One skilled in the relevant art will recognize, however, that the invention can be practiced without one or more of the specific details, or with other systems, methods, components, materials, parts, and the like. In other instances, well-known structures, materials, or operations are not shown or described in detail to avoid obscuring aspects of the invention.

Reference throughout this specification to “one embodiment”, “an embodiment”, or “a specific embodiment”, means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

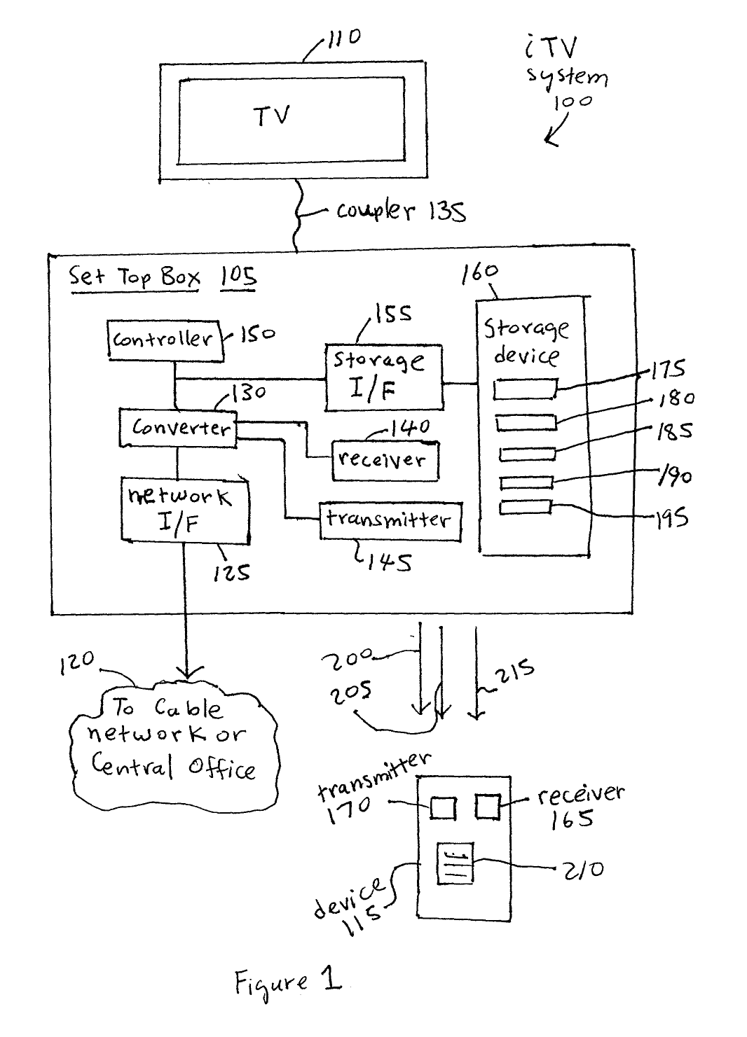

FIG. 1 is a block diagram of an interactive television (interactive TV or iTV) system 100 that can implement an embodiment of the invention. However, other types of systems may also be used to implement an embodiment of the invention. The iTV system 100 typically includes a set top box (or other customer premises equipment) 105, television (display device) 110, and a notification device 115. The notification device 115 may be, for example, a remote control device. In the description herein, the customer premise equipment 105 is shown and described as a set top box. However, the customer premise equipment may also be other types of suitable devices. Set top box 105 may be a consumer electronics device that serves as a gateway between the television 110 and a broadband communication network, such as a cable network 120. The connection to the broadband communication network may continue to a data communication network, such as the Internet, by way of, for example, a public switched telephone network (PSTN). The set top box 105 receives the programming content or television signals from the broadband communication network, and delivers the television signals to the television 110. The set top box 105 also enables a viewer to select a television program to view and then delivers the television program to the television 110. Alternatively or in addition, the television signals can be broadcast over a wireless medium and received by a traditional aerial antenna or by a satellite dish, and then delivered to the set top box 105.

As its name implies, a set top box is typically located on top of, or in close proximity to, a television. Alternatively or additionally, features and functionality of a set top box may be integrated into a type of advanced television or other display device. For example, the features of the set top box 105 can be built into circuitry of the television set 110 (e.g., an interactive television set). Another example is where there may be multiple set top boxes or where there is an “updated or expanded” set top box connected to the main set top box.

The set top box 105 typically includes a network interface 125 for interfacing with a broadband network such as the cable network 120. The network interface 125 may also interface with a Central Office (CO) in the telephone industry, where the Central Office routes audio streams and other data to and from the various set top boxes serviced by the Central Office. The set top box 105 may also include a converter 130 for converting digitally-encoded data streams (e.g., television signals) into a format directly readable by television 110. The set top box 105 receives the data streams from, for example, a broadband communication network, such as the cable network 120. As another example, the data stream is transmitted over a wireless medium and received by a traditional aerial antenna or by a satellite dish, and then delivered to the set top box 105. The digital encoding for the data streams may be, for example, in the Moving Pictures Experts Group (MPEG) format. The incoming data stream is processed by the set top box 105 and transmitted via coupler 135 for display on television 110. The coupler 135 may be, for example, a data transmission wire or a wireless path.

In the specific embodiment shown in FIG. 1, set top box 105 is further equipped with a receiver, such as an infrared (IR) or radio frequency (RF) receiver 140. In other embodiments, the receiver 140 may be configured to receive other frequencies of the electromagnetic spectrum such as, for example, Ultrahigh Frequency (UHF), Very High Frequency (VHF), microwave, or other frequencies. Receiver 140 receives control signals from the notification device 115 for operating the set top box 105 and the television 110, according to an embodiment of the invention. In one embodiment, the set top box 105 is further equipped with a transmitter 145, such as an IR or RF transmitter, for transmitting signals to the notification device 115, as further described below. In other embodiments, the transmitter 145 may be configured to transmit other frequencies of the electromagnetic spectrum such as, for example, UHF, VHF, microwave, or other frequencies. In another embodiment, the functions of the receiver 140 and the transmitter 145 may be performed by a single component such as a transceiver (not shown in FIG. 1).

In the specific embodiment shown in FIG. 1, set top box 105 further includes a controller (processor) 150 that is coupled with a storage interface 155 and the converter 130. The storage interface 155 provides an interface with a digital storage device 160, such as a hard disk drive or other memory device. In operation, the storage interface 155 may receive information from receiver 140 and deliver the information to the digital storage device 160 for storage. The storage interface 155 may also transmit information from the digital storage device 160 to the transmitter 145 so that the information is then transmitted to a receiver 165 of the notification device 115. The receiver 140 of set top box 105 may receive signals from a transmitter 170 of notification device 115.

In this illustrated embodiment, digital storage device 160 can store information received from the cable network 140 or a Central Office. The digital storage device 160 can also store the various software such as, for example, an email engine 175 for permitting e-mail messages to be transmitted from and received by the set top box 105 and for performing other functions related to email messaging. However, the email engine 175 may also be stored in another storage device that can be accessed by controller 150. Email engine 175 may be, for example, a program, module, instructions, or the like.

Controller 150 typically manages the operation of the set top box 105, including, for example, the execution of software to permit the storage and retrieval of information in storage device 160 and other memory, the transmission of information to and reception of information from the network 120 or a central office, and the like. The controller 150 may perform these and other operations based on, for example, control signals generated by the notification device 115 and transmitted to the receiver 140.

Controller 150 may be embodied as, for example, a micro-controller, microprocessor, digital signal processor (DSP), Application Specific Integrated Circuit (ASIC), field programmable gate array (FPGA), or other suitable devices. The controller 150 is in communication with the transmitter 145, receiver 140, converter 130 (and/or network interface 125), storage interface 155, and particular applications that may be included in the set top box 105.

In the specific embodiment shown in FIG. 1, set top box 105 further includes one or more applications 180 for performing various operations. For example, the application 180 may include a browser for accessing a Uniform Resource Locator (URL) address on the Internet and for permitting web pages in a URL address to be displayed on the television 110. It is noted that the application 180 may represent one or more application. The application 180 may also be stored in the digital storage device 160.

In one embodiment, a module 185 serves as a middleware that interfaces with email engine 175 and other modules that may be used when processing email messages that are received by set top box 105 from a data communications network or sent by the set top box 105 to the data communications network. The module 185 may also provide the interface between other applications. As known to those skilled in the art, middleware is software that connects two otherwise separate applications. For example, there are a number of middleware products that link a database system to a Web server. This allows users to request data from the database using forms displayed on a Web browser, and the middleware enables the Web server to return dynamic Web pages based on the user's requests and profile. Middleware is sometimes called “plumbing” because it connects two sides of an application and passes data between them. One example of a suitable middleware that can be used to implement the module 185 is of the type available from Liberate Technologies, 2 Circle Star Way, San Carlos, Calif. 94070-6200.

In one embodiment, email engine 175 detects when an email message has been received by set top box 105 and enables the transmitter 145 to send a signal 200 to the notification device 115. The receiver 165 of notification device 115 receives the signal 200 and the signal 200 is processed to notify the user of notification device 115 that a new email message has been received. The email engine 175 also permits the display of the email message on the screen of the television 110, the creation and transmission of an email message from the iTV system 100, and other email processing functions.

In one embodiment, a module 190 serves as an instant messenger engine (application) for detecting when an individual is on-line in a data communications network for a chat session. Accordingly, the module 190 may enable the transmitter 145 to send a signal 205 to the notification device 115. The receiver 165 of notification device 115 receives the signal 205 and the signal 205 is processed to notify the user of notification device 115 that an individual is on-line for a chat session.

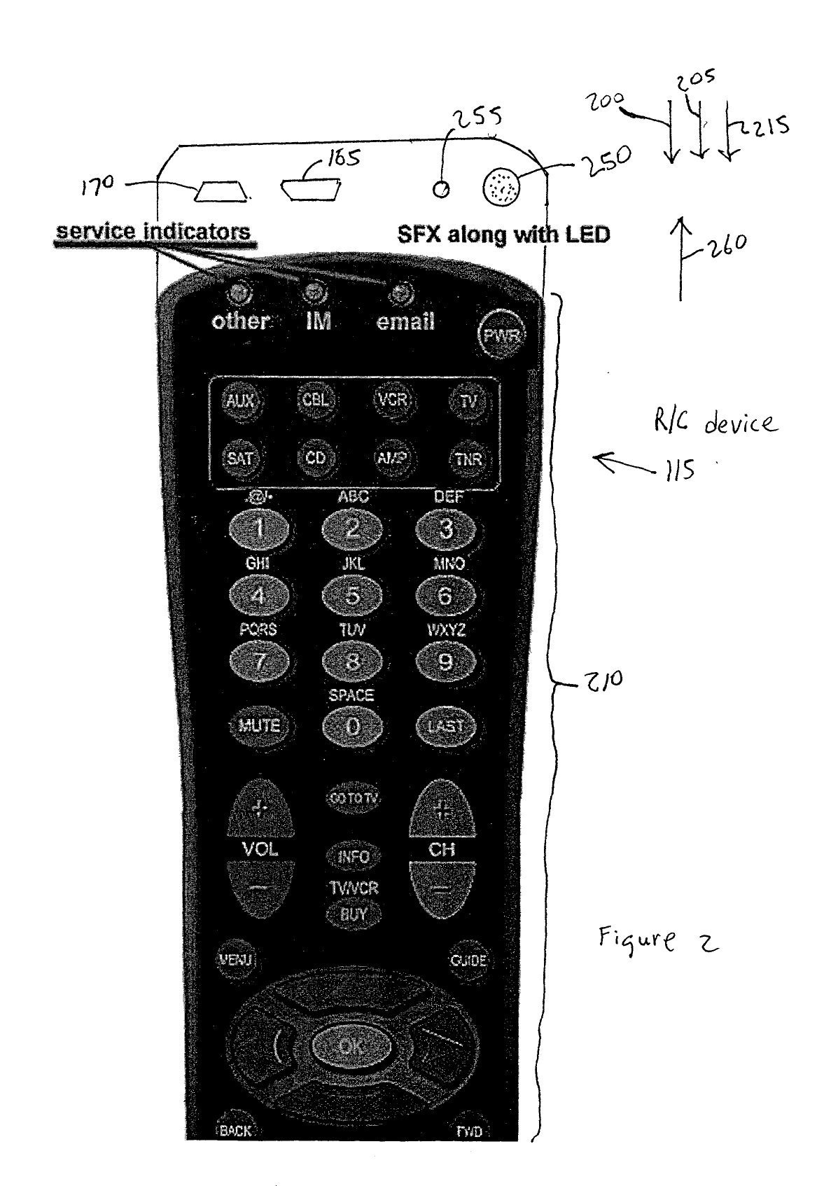

A module 195 may also permit the function of a customized service, or other services or options. When the customized service or other service/option is performed or selected, the transmitter 145 transmits a signal 215 which is received by the receiver 165. After receiving the signal 215, in one embodiment, an “other” light emitting diode (FIG. 2) turns on in the notification device 115 to alert the user that the customized service or other service/option has been selected or is functioning.

In one embodiment, the notification device 115 provides convenient remote control operation of the set top box 105 and/or the television 110. The notification device 115 may suitably include control buttons 210 for particular operations. As used herein, the term “button” contemplates other types of controls, such as switches, touch-screen controls, and the like. In addition, multiple buttons or controls may be provided for performing a particular function. Thus, the term “button” means one or more controls for performing the stated function.

In the specific embodiment shown in FIG. 1, notification device 115 typically includes the receiver 165 such as, for example, an RF or IR receiver, for receiving signals transmitted by the transmitter 145 of the set top box 105. Notification device 115 further includes the transmitter 170 such as, for example, an RF or IR transmitter, for transmitting control signals (commands) and other data to the receiver 140 of the set top box 105. The notification device 115 can also transmit signals to the television 110 in order to enable certain operations, such as the adjustment of the television volume and the like. In another embodiment, the functions of the receiver 165 and the transmitter 170 may be performed by a single component such as a transceiver (not shown in FIG. 1).

In one embodiment, the transmitters 145 and 170 modulate signals with a carrier frequency to enable transmission of information between set top box 105 and notification device 115. For example, transmitters 145 and 170 may operate according to Institute of Electrical and Electronics Engineers (IEEE) 802.11a or 802.11b Wireless Networking Standards. In another embodiment, transmitters 145 and 170 may rely on the Digital Enhanced Cordless Telecommunications (DECT) technology, the “Bluetooth” protocol, or other suitable standard or proprietary protocols. In another embodiment, the transmitters 145 and 170 may rely on technology that is of the type used by the Apple Airport™ wireless transmission system. Modulation techniques may include spread spectrum, frequency shift keying, multiple carrier, or other known techniques. To achieve signal modulation and transmission, transmitters 145 and 170 may include various additional components not specifically illustrated. For example, transmitters 145 and 170 may include source encoders to reduce the amount of bandwidth required, channel encoders to modulate the transmitted information with a carrier wave, and transmission antennas to permit signal broadcast. An antenna for the transmitter 145 may be, for example, a substantially two-dimensional structure formed as part of a printed circuit board within the set top box 105. Similarly, an antenna for the transmitter 170 may be, for example, a substantially two-dimensional structure formed as part of a printed circuit board within notification device 115. Such integrated antennas are advantageously compact and efficient to manufacture. Transmitters 145 and 170 may further include amplifiers to increase the transmission signal strength to an appropriate power level.

To permit signal reception and de-modulation, receivers 140 and 165 may include various additional components not specifically illustrated. For example, receivers 140 and 165 may include antennas for receiving the transmitted signal, amplifiers for increasing the strength of the received signal, and decoders for separating and demodulating the received information from the carrier signal. The antenna of the receiver 140 may be formed as part of a printed circuit board within the set top box 105, while the antenna of the receiver 165 may be formed as part of a printed circuit board within the notification device 115.

In various embodiments, the notification device 115 is also in communication with a processor (not shown) such as a microprocessor or digital signal processor (DSP) that senses a user's operation of the buttons of the notification device 115 and generates appropriate command signals for transmission to the set top box 105 and/or television 110 to permit various operations.

The various components of the notification device 115 may be positioned in different locations for functionality, ergonomics, ease-of-use, and/or other purposes. For example, as shown in FIG. 1, the buttons 210 may be located centrally in the notification device 115.

Of course, the illustrated configuration of set top box 105 and notification device 115 in FIG. 1 is provided for example purposes only, and other types of configurations may be used within the scope of the invention.

FIG. 2 is a block diagram of a notification device 115 according to a specific embodiment of the invention. Although the notification device 115 is shown as a remote control device for controlling the display device 110 and the customer premise equipment 105, the notification device 115 may alternatively be other types of portable devices such as a pager, cellular or cordless phone, palm pilot, personal digital assistant, computer notebook or laptop, portable stereo device, or other suitable portable devices. The receiver 165 receives alert signals (e.g., signals 200, 205, or 215) from the transmitter 145 of the set top box 105. After the receiver 165 receives an alert signal, at least one of the following functions are enabled: (1) an “email” light emitting diode (LED) turns on if an email message is received by the STB 105 and detected by the email engine 175 (FIG. 1); (2) an “IM” LED turns on when the instant messenger application 190 (FIG. 1) has detected an individual who is on-line for a chat session (e.g., if an individual is trying to reach a user of the iTV system 100 by use of an instant messaging service); and (3) an “other” LED turns on if other services, options, or alert functions are executed in the set top box 105. The LEDs described above may turn on in a flashing or non-flashing manner.

In another embodiment, in addition or as an alternative to the alert functions described above, after the receiver 165 receives the alert signal 200, 205 or 215, an alert sound (e.g., a tone, chime, buzz, ring, recorded voice alert notification, or beep) may be broadcasted by a speaker 250 of the notification device 115. In addition or as an alternative, after the receiver 165 receives the signals 200, 205 or 215, the notification device 115 may vibrate. Thus, the notification device 115 effectively functions as a portable device that pages the user if an email has been received by the set top box 105, if an individual is on-line for a chat session, and/or if other services or options have been selected or are functioning. It is noted that at least one of the alert signals described above may be omitted and that other types of alert signals may be substituted or added to the embodiments described herein.

In one embodiment, a control button 255 on the notification device 115 may be selected by the user to permit the transmitter 170 to transmit a command signal 260 that is received by the receiver 140 of the set top box 105. The control signal 260 permits the controller 150 to send control signals to turn on the television 110 and/or to execute the email engine 175 so that the email message inbox and/or the newly-received email message is displayed on the screen of the television 110.

In one embodiment, the wireless transmission protocol that is used by the set top box 105 and notification device 115 permits control signals to be transmitted through walls of a house or building. Additionally, a wireless transmission protocol that is used may be of long range capability so that the user of the notification device 115 can move freely at farther distances from the location of the set top box 105, and yet at the same time, be notified if, for example, an email message or instant message is received by the set top box 105.

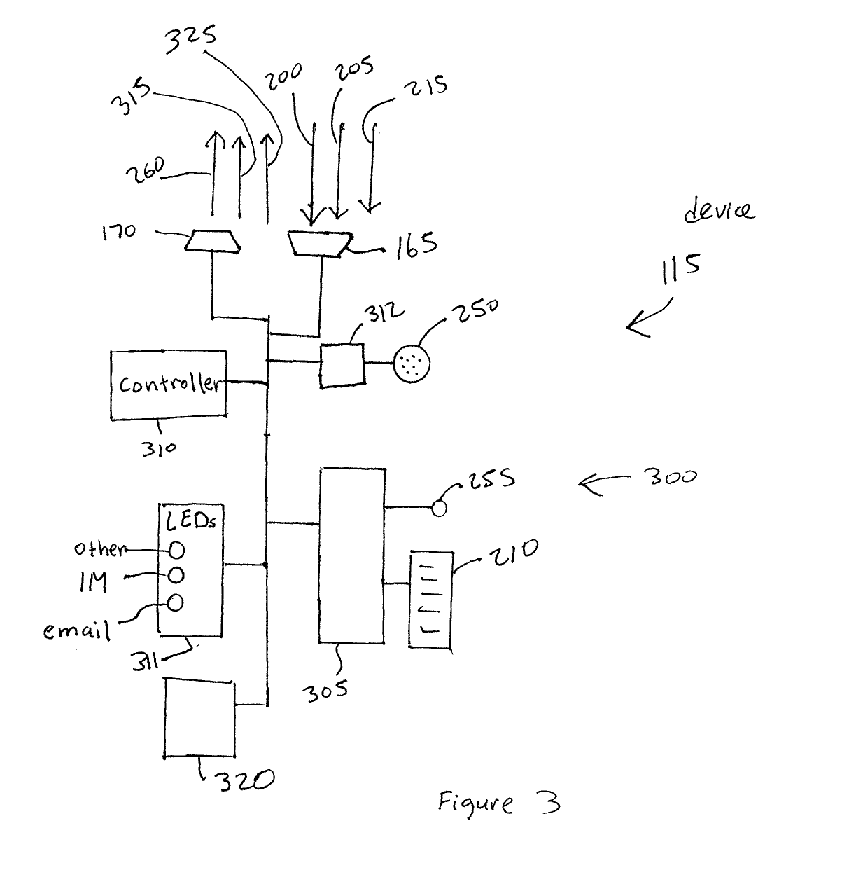

FIG. 3 is a block diagram of various components in the notification device 115 according to an embodiment of the invention. Of course, the illustrated system of FIG. 3 is provided for example purposes only, and other types of systems and system configurations may be used within the scope of the invention. The notification device 115 includes a notification system 300 for permitting various functions in the notification device 115. A module 305 may include conventional circuitry, mechanism, software, and/or code for permitting various functions in the notification device 115. For example, the module 305 processes the commands when one or more of the control buttons 210 or control button 255 are pressed or selected by the user. A controller 310 manages various operations in the notification system 300. For example, in response to a user's selection of one or more of the buttons 210, the controller 310 enables the transmitter 170 to send an appropriate command 315 which is received by the receiver 140 (FIG. 1) and processed by the controller 150 of the set top box 105. As another example, if the user presses button 255, then the controller 310 permits the transmitter 170 to send the command 260 which causes the television 110 to turn on and/or which causes the execution of the email engine 175 so that the email message inbox and/or the newly-received email message is displayed on the screen of the television 110. As another example, in response to a user's input command, the controller 310 permits the transmitter 170 to send a command 325 which causes the execution of the instant messenger application 190 (FIG. 1) SO that the instant messaging function is displayed in the television 110.

The controller 310 may also be programmed so that the following functions can be performed. When any of the signals 200, 205, 215 are received by the receiver 165 from the set top box 105, the controller 310 permit any of the following or any combination of the following: (1) the lighting or flashing of at least one of the “other” LED, “IMN” LED or “email” LED as controlled by LED control stage 311; (2) an alert tone, buzz, voice simulation, or other sound that is broadcast from speaker 250 as controlled by sound generation stage 312; or/and (3) the vibration of the notification device 115 by use of a conventional vibration module 320.

It is noted that at least one command above may be omitted and that other types of commands may be included in or substituted in an embodiment of the invention.

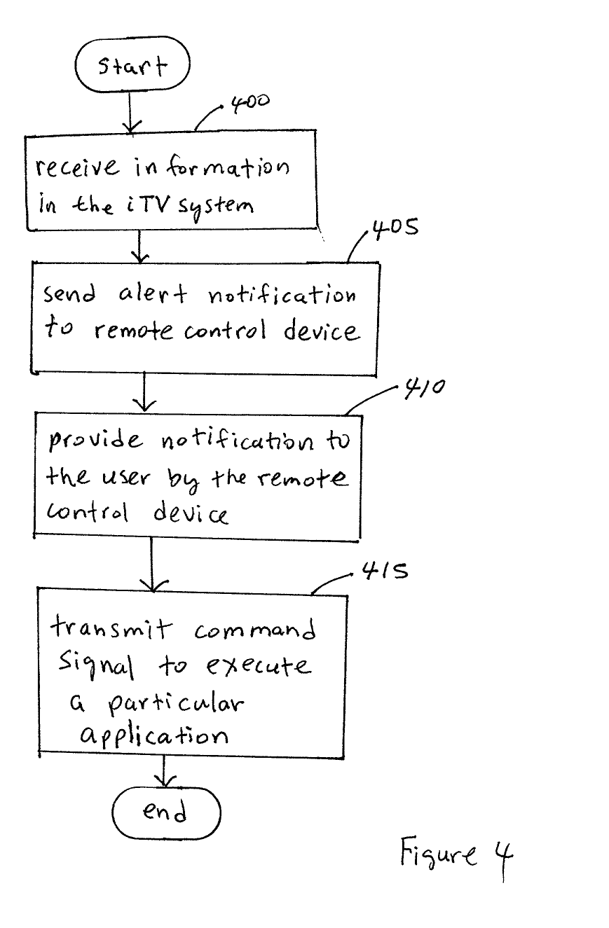

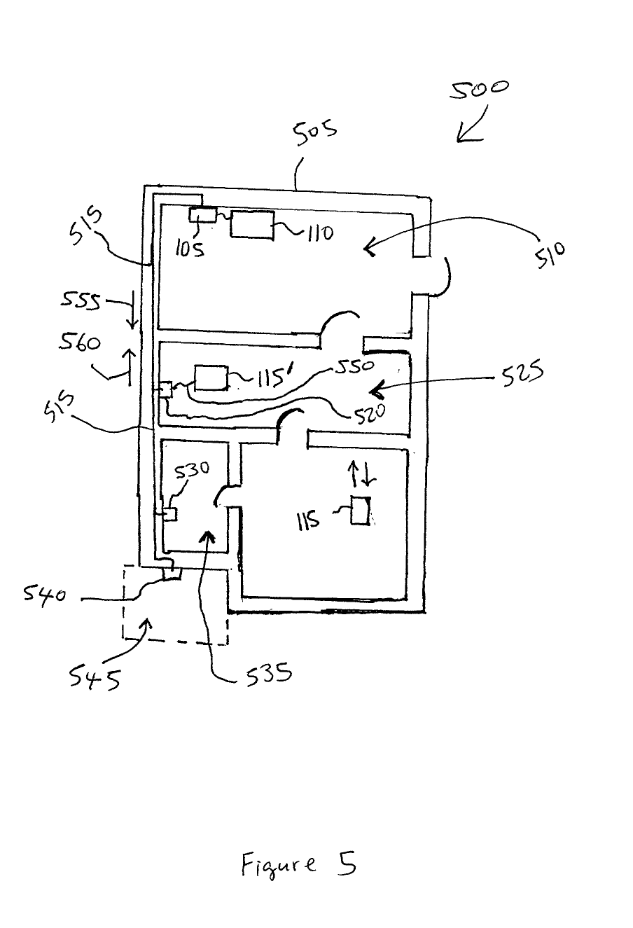

FIG. 4 is a flowchart of a method to permit remote notification to an interactive television user according to an embodiment of the invention. An interactive television system first receives (400) information from, for example, a data communications network. The received information may be, for example, an email message, instant message, or other information. As an example, the other information may be a voice mail message if the interactive television system is capable of receiving and storing voice mail messages. An alert notification is then sent (405) to a notification device to notify the user of the newly-received information. In response to the alert notification, the notification device will provide (410) a notification to the user. The user may enable the transmission (415) of a command signal for executing an application related to the alert notification. For example, if an alert notification is sent to the notification device to indicate a new email message, a command signal may be transmitted by the notification device to permit an email application to display an email message inbox in the television screen. FIG. 5 is a block diagram of an interactive television system 500 according to another specific embodiment of the invention. The iTV system 500 may be implemented in a structure 505 such as a residential dwelling or a business office. The customer premise equipment 105 (e.g., a set top box) and display device 110 (e.g., a television) may be in a room 510 of the structure 505. A wired link 515 may connect the customer premise equipment 105 to a terminal (or interface) 520 that is located in another room 525 of the structure 505. The wired link 515 may also connect the customer premise equipment 105 to another terminal 530 in another room 535 of the structure 505. As another example, the wired link 515 may also connect the customer premise equipment 105 to another terminal 540 that is located externally to the structure 505. For example, the terminal 540 may be in a patio or balcony area 545 adjacent to the structure 505. Other terminals may also be connected to the wired link 515.

The wired link 515 may be, for example, cable wiring that is routed within various areas such as walls or floors, of the structure 505. Alternatively or in addition, the wired link 515 may be other types of wiring that is routed within various areas of the structure 505.

A notification device 115′ may be connected to any one of the terminals 520, 530, and 545 (and/or other terminals) by use of a connector 550. Alternatively or in addition, a notification device 115′ may be connected to at least two of the terminals 520, 530, and 545 (and/or other terminals) simultaneously. The notification device 115′ may include a suitable interface stage (not shown in FIG. 5) that permits the device 115′ to receive notifications signals 555 via wired link 515 from the customer premise equipment 105 and to send command signals 560 to the customer premise equipment 105. The notification signals 555 may include signals that are transmitted after the customer premise equipment 105 receives a new email message, an instant message, and/or other information, as similarly described above. The notification device 115′ receives and processes the notification signals 555 to notify a user that a new email message, an instant message, and/or other information have been received by the customer premise equipment 105 from, for example, the cable network 120.

The notification device 115′ can also transmit control signal (or control signals) 560 to permit various functions such as: (1) permitting the display device 110 to turn on; (2) permitting the display of the email message inbox in the display device 110; (3) permitting the display of a newly-received instant message in the display device 110; and/or (4) permitting the display of other information in the display device 110 and/or the execution of other functions in the iTV system 100.

The notification device 115′ may also be configured to receive alert signals from and send command signals to the customer premise equipment 105 by use of a wireless link, as similarly described above for the notification device 115 of FIG. 1. In addition, the notification device 115 of FIG. 1 (as described above) may also receive alert signals from and send command signals to the customer premise equipment 105, even if a notification device 115′ is coupled to at least one of the terminals 520, 530, and 540.

Other variations and modifications of the above-described embodiments and methods are possible in light of the foregoing teaching. For example, the notification device 115 may be configured with an LED screen so that the user is alerted by text or icon displayed on the screen that an email message, instant message, or other information/services has been received by the iTV system 100 .

Further, at least some of the components of this invention may be implemented by using a programmed general purpose digital computer, by using application specific integrated circuits or field programmable gate arrays, or by using a network of interconnected components and circuits. Connections may be wired, wireless, by modem, and the like.

It is also within the scope of the present invention to implement a program or code that can be stored in an electronically-readable medium to permit a computer to perform any of the methods described above.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus for providing notification to a user of an interactive television system, the apparatus comprising:
a customer premise equipment capable to receive information from a data communication network and transmit an alert signal in response to receiving the information; and
a notification device capable to receive the alert signal and to provide notification to a user in response to the alert signal.

2. The apparatus of claim 1 wherein the customer premise equipment includes a set top box.

3. The apparatus of claim 1 wherein the notification device comprises a remote control device.

4. The apparatus of claim 1 wherein the received information includes an electronic mail.

5. The apparatus of claim 1 wherein the received information includes an instant message.

6. The apparatus of claim 1 wherein the notification includes a light signal from the notification device.

7. The apparatus of claim 1 wherein the notification includes a sound signal from the notification device.

8. The apparatus of claim 1 wherein the notification includes vibration from the notification device.

9. The apparatus of claim 1 wherein the alert signal is capable to penetrate a wall or barrier.

10. The apparatus of claim 1 wherein the customer premise equipment includes a transmitter capable to transmit the alert signal.

11. The apparatus of claim 1 wherein the notification device includes a receiver capable to receive the alert signal.

12. The apparatus of claim 1 wherein the notification device is capable to transmit a control signal that permits execution of an application for processing the received information.

13. The apparatus of claim 1 wherein the customer premise equipment includes an application capable to detect the received information.

14. The apparatus of claim 1 wherein the customer premise equipment includes an application capable to display the received information.

15. The apparatus of claim 1, further comprising:
a display device communicatively coupled to the customer premise equipment and capable to display the received information.

16. The apparatus of claim 1 wherein the notification device is communicatively coupled to the customer premise equipment by a wireless link.

17. The apparatus of claim 1 wherein the notification device is communicatively coupled to the customer premise equipment by a wired link.

18. The apparatus of claim 17 wherein the wired link is cable wiring.

19. A method of notifying a user of an interactive television system, the method comprising:
receiving, by a customer premise equipment, information from a data communication network;
in response to the received information, sending an alert signal to a notification device; and
in response to the alert signal, providing notification by the notification device about the received information.

20. The method of claim 19, further comprising:
transmitting a command signal from the notification device to the customer premise equipment to execute an application capable to process the received information.

21. The method of claim 19 wherein the customer premise equipment includes a set top box.

22. The method of claim 19 wherein the notification device comprises a remote control device.

23. The method of claim 19 wherein the received information includes an electronic mail.

24. The method of claim 19 wherein the received information includes an instant message.

25. The method of claim 19 wherein providing notification comprises:
providing a light signal from the notification device.

26. The method of claim 19 wherein providing the notification comprises:
providing a sound signal from the notification device.

27. The method of claim 19 wherein providing the notification comprises:
providing vibration from the notification device.

28. An article of manufacture, comprising:
a machine-readable medium having stored thereon instructions to:
receive, by a customer premise equipment, information from a data communication network;
in response to the received information, send an alert signal to a notification device; and
in response to the alert signal, provide notification by the notification device about the received information.

29. An apparatus for notifying a user of an interactive television system, the apparatus comprising:
means for receiving information from a data communication network;
communicatively coupled to the receiving means, means for sending an alert signal in response to the received information; and
communicatively coupled to the receiving means, means for providing notification about the received information in response to the alert signal.

30. An apparatus for providing notification to a user of an interactive television system, the apparatus comprising:
a customer premise equipment capable to receive information from a data communication network and transmit an alert signal in response to receiving the information, the customer premise equipment including a set top box capable to process the received information;
a notification device capable to receive the alert signal and to provide notification to a user in response to the alert signal; and
a display device communicatively coupled to the customer premise equipment and capable to display the received information;
wherein the customer premise equipment includes an application capable to detect the received information, and an application capable to display the received information;
wherein notification is provided by using at least one signal from a group of signals comprising a light signal, a sound signal, and a vibration signal.

31. An apparatus for providing notification to a user of an interactive television system, the apparatus comprising:
a customer premise equipment capable to receive information transmitted from a data communication network, the customer premise equipment capable to transmit an alert signal in response to receiving the information;
a notification device capable to provide control signals to control the customer premise equipment, the notification device capable to receive the alert signal and process the alert signal to generate a notification related to the received information; and
a display device communicatively coupled to the customer premise equipment and capable to display the received information;
wherein the customer premise equipment includes an application capable to detect the received information, and an application capable to display the received information;
wherein notification is provided by using at least one signal from a group of signals comprising a light signal, a sound signal, and a vibration signal.

32. A method of notifying a user of an interactive television system, the method comprising:
receiving, by a customer premise equipment, information from a data communication network, and storing the received information;
in response to the received information, sending an alert signal to a notification device;
receiving and processing the alert signal; and
based upon the alert signal, providing notification by the notification device about the received information;
wherein notification is provided by using at least one signal from a group of signals comprising a light signal, a sound signal, and a vibration signal.
